(19) United States
(12) Patent Application Publication
(10) Pub. No.: US 2021/0403277 A1
(43) Pub. Date: Dec. 30, 2021

(54) SYSTEMS AND METHODS FOR AUTO-TUNING ELEVATOR CONTROLLERS

(71) Applicant: TK Elevator Innovation and Operations GmbH, Duesseldorf (DE)

(72) Inventors: Gabriel Pascottini Flores, Porto Alegre (BR); Chih Hung A. King, Sharpsburg, GA (US)

(73) Assignee: TK Elevator Innovation and Operations GmbH, Duesseldorf (DE)

(21) Appl. No.: 17/358,659

(22) Filed: Jun. 25, 2021

Related U.S. Application Data
(60) Provisional application No. 63/044,088, filed on Jun. 25, 2020.

(51) Int. Cl. B66B 1/30; B66B 1/34; B66B 5/00

(52) U.S. Cl. CPC B66B 1/30; B66B 5/0018; B66B 1/3461

(57) ABSTRACT

Embodiments herein are directed to an elevator system having at least one movable component and at least one component generating a reference signal. The elevator system includes a controller, an output signal, and a controller tuner. The controller generates a control signal. The output signal is indicative of a movement of the at least one movable component of the elevator system based on the control signal. The controller tuner is communicatively coupled to the controller. The controller tuner receives the output signal and the reference signal to calculate an error signal. The controller tuner uses the error signal to calculate a corrected control signal and transmits the corrected control signal to the controller. The corrected control signal manipulates the control signal generated by the controller to change the movement of the at least one movable component.

### CROSS REFERENCE TO RELATED APPLICATIONS

The present application claims priority to U.S. Provisional Patent Application Ser. No. 63/044,088, filed on Jun. 25, 2020, and entitled “Auto-Tuning Systems and Methods for Elevator Controllers” which is incorporated by reference herein in its entirety under 35 U. S.C. 119(e).

### TECHNICAL FIELD

The present disclosure relates generally to elevators, including systems and methods for autonomously and/or automatically retuning controllers of elevator systems to enhance performance, passenger comfort, efficiency, and the like.

### BACKGROUND

Components of elevator systems experience mechanical stresses that over time lead to degradation of those components. Degradation is relative, and degradation of a component does not necessarily mean that the component has failed or needs replacement. However, degradation of a component may affect elevator performance and/or efficiency, even where such degradation is not critical. In some cases, the effects of degraded components may be imperceptible and may not require any action. In other cases, the effects of degraded components may be severe and thus easily perceived, particularly where the effects of multiple degraded components compound.

As a result of the degradation of mechanical components, an elevator might, for example, become slow, accelerate or decelerate too fast, experience reduced ride quality, fail to align precisely with floor doors, consume unnecessary power, and the like. The same or similar effects may be experienced due to the degradation of certain electrical components. Several examples of component degradation that can trigger losses in elevator performance and/or efficiency over time include stretched ropes/belts, sensor de-calibration, and degraded guides, gears, and electrical components. In severe cases, a technician typically replaces components or manually adjusts parameters of the elevator system. However, the first option is expensive and amounts to a waste of money if the replaced components are otherwise healthy. The second option is time consuming and inefficient.

Many, if not most, effects of degraded components that negatively impact performance and passenger comfort can be mitigated by retuning a controller of a drive assembly of an elevator system. Retuning this controller can improve performance because such controllers are tuned initially based on brand new components that have not yet experienced any degradation. Some aspects of elevator systems can be manually retuned, but manual retuning is time consuming, inefficient, and imprecise. Further, manual retuning and known retuning approaches generally fail to leverage the array of data that some modern elevator systems monitor and collect.

### SUMMARY

An elevator system having at least one movable component and at least one component generating a reference signal is provided. The elevator system includes a controller, an output signal, and a controller tuner. The controller generates a control signal. The output signal is indicative of a movement of the at least one movable component of the elevator system based on the control signal. The controller tuner is communicatively coupled to the controller. The controller tuner receives the output signal and the reference signal to calculate an error signal. The controller tuner uses the error signal to calculate a corrected control signal and transmits the corrected control signal to the controller. The corrected control signal manipulates the control signal generated by the controller to change the movement of the at least one movable component.

In another embodiment, a method for autonomously retuning an elevator system is provided. The elevator system has at least one movable component. The method includes analyzing, by a monitoring system, an output signal of the elevator system, the output signal is indicative of a movement of the at least one movable component, determining, by the monitoring system, when a retune of a controller that generates a control signal is required, the controller having a plurality of preset parameters that influence the control signal which controls the movement of the at least one movable component, and gathering, by the monitoring system, a plurality of data related to operations of the at least one movable component associated with the output signal based on the control signal. The method continues by computing via an algorithm, by a controller tuner, a new set of the plurality of preset parameters, the new set of the plurality of preset parameters having at least one parameter different from the plurality of preset parameters, transmitting, by the controller tuner, a corrected control signal to the controller, and applying, by the controller, the corrected control signal to the at least one movable component to change the movement of the at least one movable component.

In another embodiment, an elevator system having an elevator car, a shaft and a drive assembly is provided. The drive assembly has an electrical machine and an inverter that cooperate to generate an output signal to cause a movement of the elevator car through the shaft. The elevator system includes a controller, a monitoring system, and a controller tuner. The controller has a plurality of preset parameters stored within the controller that generates a control signal. The monitoring system remotely monitors the output signal of the elevator system. The controller tuner is communicatively coupled to the controller and to the monitoring system. The controller tuner includes a data driven algorithm that autonomously calculates a corrected control signal. The corrected control signal has a new set of the plurality of preset parameters. The controller tuner transmits the corrected control signal to the controller. The transmitting of the corrected control signal to the controller manipulates at least one of the plurality of preset parameters based on the new set of the plurality of preset parameters to change the control signal of the controller to change the movement of the elevator car through the shaft.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a flow diagram depicting an example flow sequence by which information, data, decisions, and/or determinations are passed from one element to another in one example system according to one or more embodiments shown and described herein;

FIG. 2 is a flow diagram depicting an example method for automatically and/or autonomously retuning elevator systems according to one or more embodiments shown and described herein;

FIG. 3 is a schematic view of one example system for automatically and/or autonomously retuning an elevator system according to one or more embodiments shown and described herein;

FIG. 4 is a system diagram of a conventional elevator system according to one or more embodiments shown and described herein;

FIG. 5 is a system diagram of an example elevator system of FIG. 3 according to one or more embodiments shown and described herein;

FIG. 6 is a block diagram of an example open-loop system of the system diagram of FIG. 5 according to one or more embodiments shown and described herein; and

FIG. 7 is a block diagram of an example closed-loop system of the system diagram of FIG. 5 according to one or more embodiments shown and described herein.

### DETAILED DESCRIPTION

Some elevator systems monitor performance and, in some instances, the conditions and/or lifetimes of their constituent components. The present disclosure generally concerns systems and methods for automatically and/or autonomously retuning controllers of drive assemblies of such elevator systems based on the data being monitored (and collected). In some examples, the present disclosure involves analyzing data gathered by one or more controllers of the elevator system in the monitoring process to assess performance. Where an elevator system is performing sub-optimally, the disclosed systems and methods of the present disclosure may recommend or, where pre-approved, self-initiate retuning of the controller of the elevator system's drive assembly. Upon entering a retuning mode, the elevator system may cause an elevator car to perform one or more data acquisition runs, if necessary, to complement data already collected during ongoing monitoring of the elevator system. A controller tuner may then calculate new parameters for the controller of the drive assembly based on various data-driven analytic methods such as, for example and without limitation, Virtual Reference Feedback Tuning (VRFT), Optimal Controller Identification (OCI), and/or Iterative Feedback Tuning (IF T).

Moreover, one example system of the present disclosure may include an elevator system condition monitoring system having a processor located at the elevator system or remote from the elevator system (e.g., cloud-based) for executing a data-driven retuning assessment algorithm. The example system may further include a controller tuner for retuning a controller of a drive assembly of the elevator system. In some embodiments, the controller tuner may be an independent computer with a printed circuit board (PCB) dedicated to determining the necessary adjustments to be implemented in the controller of the drive assembly. In other embodiments, the controller tuner may be a particular process/thread running on a general controller of the elevator system or may be part of the controller of the drive assembly. Notwithstanding, the monitoring system may periodically or, in some instances, constantly evaluate the need to retune the controller of the drive assembly.

In cases where retuning is not pre-approved, a technician may receive a notification when the system identifies a need for retuning. In some embodiments, the system may further include a mobile device graphical user interface (GUI) that allows retuning to be remotely authorized or triggered by the technician, for instance. A GUI at a control panel of an elevator system could likewise allow someone to authorize or trigger retuning. Nonetheless, depending on the service agreement with the customer, the technician may then contact the customer offering the retuning service. In other embodiments, the customer may have previously approved such retunes or paid for a service model that includes such retunes. In still other cases, the system may be configured to commence retuning without the need for approval at each successive retune. Indeed, in some instances the system may be configured to retune as often as the monitoring system deems necessary (e.g., every fifteen minutes, hourly, daily, weekly, monthly), at least to the extent that retuning does not consume an inordinate amount of resources and inundate the elevator system. The system may also be configured such that only certain types of adjustments being made in the retuning process require approval before implementation.

In some embodiments, retuning may be scheduled, as needed or at regular intervals, during periods when the elevator system experiences the least amount of traffic (e.g., weekends or overnight). It should be further understood that retuning may be initiated or at least recommended every time a component is replaced on the elevator system, even if the replaced component is virtually the same as the component being replaced, as two components typically never have exactly the same attributes. Those having ordinary skill in the art will further understand that the present disclosure is equally applicable to the initial tuning of the controller of the drive assembly, not just retuning. For the sake of simplicity, though, the description herein will refer to retuning. Tuning new elevator installations according to the disclosed methods would, at the very least, accelerate an adjustment phase for job delivery.

Although certain example methods, systems and assemblies are described herein, the scope of coverage of this disclosure is not limited thereto. On the contrary, this disclosure covers all methods, systems, assemblies, apparatuses, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claim need not necessarily be performed in the order in which they are recited, unless so required by the context of the claims. In addition, all references to one skilled in the art shall be understood to refer to one having ordinary skill in the art.

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

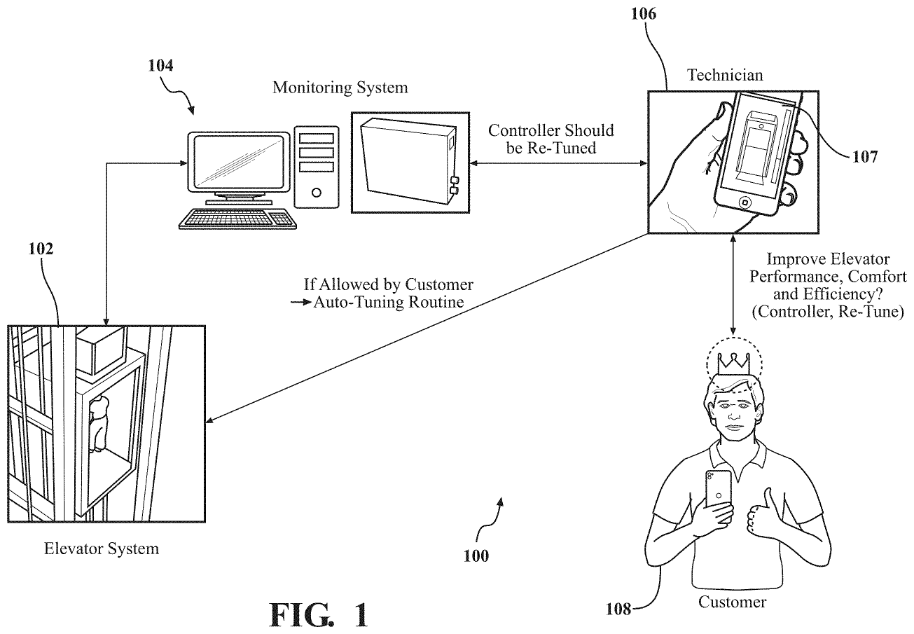

With reference to FIG. 1, example methods and systems of the present disclosure for automatically and/or autonomously retuning elevator systems may involve an example operational flow sequence 100. It should be appreciated that the example operational flow sequence 100 may depict an illustrative computing network including components for identifying when to automatically and/or autonomously retune controllers of elevator systems based on the data being monitored. As such, the components illustrated in FIG. 1, may be communicatively coupled (illustrated by the lines and arrows) to one another via a wide area network (WAN), such as the internet, a local area network (LAN), a mobile communications network, a public service telephone network (PSTN) a personal area network (PAN), a metropolitan area network (MAN), a virtual private network (VPN), and/or another network. The illustrative computing network may generally be configured to electronically connect one or more computing devices and/or components thereof.

Operation of an elevator system 102 may generate data that is monitored and analyzed by a monitoring system 104. The monitoring system 104 may be located at the elevator system 102, remote from the elevator system 102 (e.g., cloud-based), or partially remote. The monitoring system 104 may execute a data-driven retuning assessment algorithm based on the data originating from the elevator system 102 to determine whether a controller of a drive assembly of the elevator system 102 needs retuning. If the monitoring system 104 determines that retuning could improve the performance and/or efficiency of the elevator system 102, approval may be sought from a technician 106 and/or others to proceed with retuning. Depending on the service agreement with a customer 108, the technician 106 may be required to gain approval of the customer 108 before initiating the retune. The technician 106 may then initiate retuning, which may involve identifying and modifying one or more operating parameters of the elevator system 102.

In some examples, the monitoring system 104 may include one or more components and/or aspects of a predictive maintenance system, such as, for example, a real-time, cloud-based predictive maintenance system that employs machine learning to increase elevator availability by reducing out-of-service scenarios through real-time diagnostics. In some embodiments, the monitoring system 104 may be a predictive maintenance system that may predict maintenance issues before they occur and flags components of elevator systems that are due to be replaced before their lifecycle lapses. Further, the monitoring system 104 operates by monitoring data from an elevator system, calculating the remaining lifetime of the elevator system's components via sophisticated algorithms that detect patterns, and determining which components will require maintenance and when. Examples of data that the monitoring system 104 collects includes machine data such as door movements, trips, power-ups, car calls, speed, acceleration and deceleration, reduced ride quality, failures of the elevator car to align precisely with floor doors, unnecessary consumption of power, error codes, and the like.

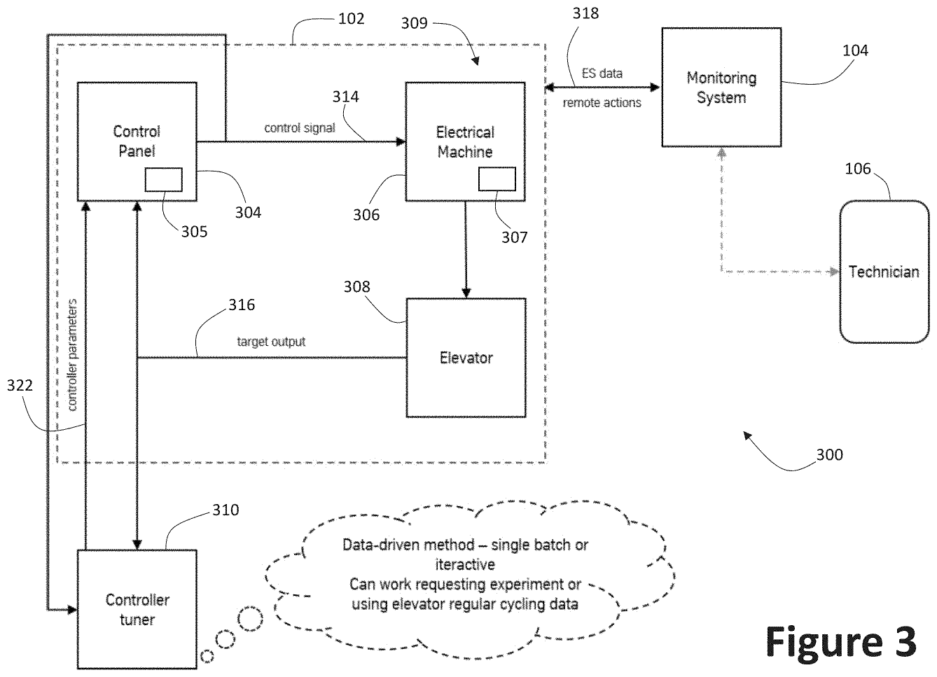

As such, the monitoring system 104 may be used as an interface between a mobile device and the technician 106, and the other components connected to the example operational flow sequence 100, and/or various other components communicatively coupled to the monitoring system 104, (such as components communicatively coupled via one or more networks to the monitoring system 104), whether or not specifically described herein. Thus, the monitoring system 104 may be used, in some embodiments, to perform one or more user-facing functions, such as receiving one or more inputs from the technician 106 or providing information to the technician 106 via an electronic mobile device, such as, without limitation, a mobile phone, a laptop, a tablet, and the like. For example, the monitoring system 104 may monitor and recognize when one or more outputs of the elevator system 102 do not meet a predetermined performance threshold, and may alert the technician 106 or may instruct a controller tuner 310 (FIG. 3) to calculate and perform a correction action, as discussed in greater detail herein.

Additionally, in the event that the monitoring system 104 and/or the controller tuner 310 (FIG. 3) require oversight, updating, or correction, the technician 106 and the electronic mobile device 107 may be configured to provide the desired oversight, updating, and/or correction. Further, the technician 106 and the electronic mobile device 107 may also be used to input additional data into a data storage portion of the monitoring system 104 and/or the controller tuner 310. For example, the technician 106 may need to use the electronic mobile device 107 to upload or change a plurality of parameters, which data of the elevator system 102 is being monitored, and/or the like. The components and functionality of the monitoring system 104 and/or the controller tuner 310 are described in greater detail herein.

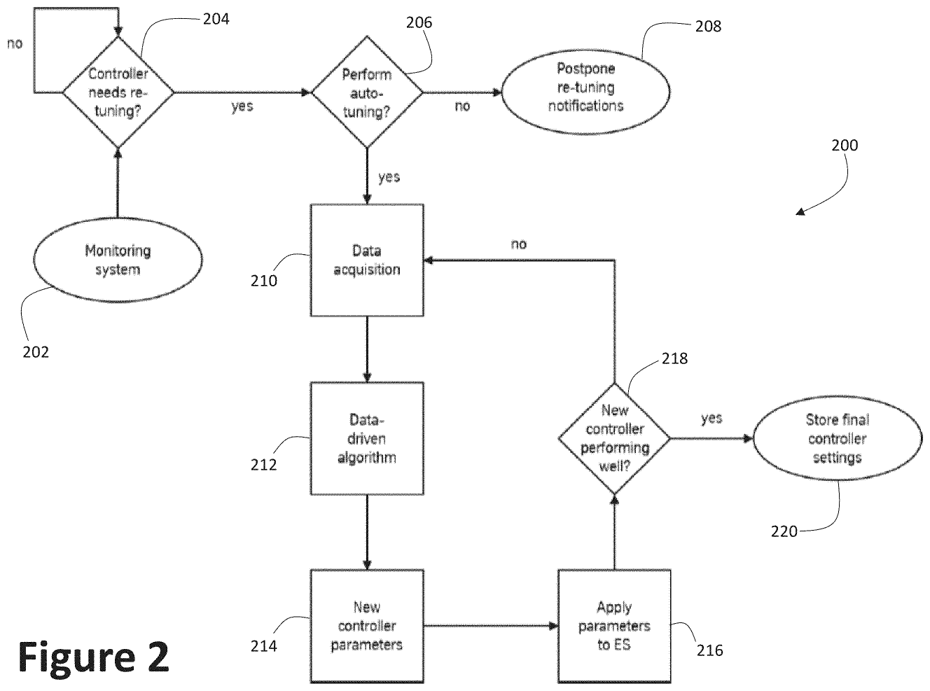

Now referring to FIG. 2, an illustrative flow diagram 200 for one example method for automatically and/or autonomously retuning an elevator system is schematically depicted. The monitoring system may initiate, at block 202, the method by analyzing data that has been or is being collected from an elevator system and determining, at block 204, periodically or continuously, if a controller of a drive assembly of the elevator system needs retuning. If the monitoring system determines that retuning is necessary, in some instances, approval must be gained, at block 206 from a technician, for example, as to whether to proceed with retuning the controller. If approval is denied, notifications about retuning may be postponed, at block 208, until, for instance, the monitoring system identifies additional and/or more-critical losses in performance and/or efficiency. If approval is gained, however, the elevator system may begin acquiring data, at block 210, to the extent necessary to supplement the data previously acquired by the monitoring system.

In some embodiments, an elevator car may need to be removed from service and moved about the shaft as supplemental data is acquired. Once a sufficient amount of data has been acquired, a controller tuner may execute a data-driven algorithm, at block 212, that generates new operating parameters, at block 214, for a controller of a drive assembly of the elevator system to implement, at block 216. After the new operating parameters are implemented in the elevator system and the monitoring system collects a sufficient amount of new data, the monitoring system may determine whether the elevator system is performing in an improved (or sufficiently improved) manner, at block 218. If so, the new operating parameters may be stored 220 and used going forward. If not, more data may be acquired, at block 210, the data-driven algorithm may be re-executed, at block 212, and new operating parameters may be generated, at block 214, for implementation at block 216 in the elevator system.

Now referring to FIG. 3, a diagram showing the exchange of information between various elements in one example system 300 for automatically and/or autonomously retuning an elevator system 102 is schematically depicted. In this example, the elevator system 102 includes a control panel 304 that may include a controller 305 for a drive assembly 309, for instance. The controller 305 interacts with the drive assembly 309 by utilizing hardware, software, and/or firmware, according to embodiments shown and described herein. In addition, the controller 305 may include a non-transitory, computer readable medium configured for displaying and/or transmitting a data that may or may not be initiated by the technician 106 embodied as hardware, software, and/or firmware, according to embodiments shown and described herein.

While, in some embodiments, the controller 305 may be configured as a general purpose computer with the requisite hardware, software, and/or firmware, in other embodiments, the controller 305 may be configured as a special purpose computer designed specifically for performing the functionality described herein. For example, the controller 305 may be a specialized device that includes a controller transfer function C(s), which includes a plurality of preset or previously determined parameters and that outputs a control signal 314 to the drive assembly 309, affecting a movement of at least one movable component of the elevator system 102, as discussed in greater detail herein.

As such, the controller 305 may include a processor, input/output hardware, network interface hardware, data storage component, and a memory component. The memory component may be non-transitory computer readable memory. The memory component may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component may be configured to store operating logic and parameter modification logic (each of which may be embodied as a computer program, firmware, or hardware, as an example).

The processor may include any processing component(s) configured to receive and execute instructions (such as from the data storage component and/or memory component). The input/output hardware may include a monitor, keyboard, mouse, printer, camera, microphone, speaker, and/or other device for receiving, sending, and/or presenting data. The network interface hardware may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component may reside local to and/or remote from the controller 305 and may be configured to store one or more pieces of data for access by the controller 305 and/or other components, store data that may be received from an external device (e.g., the elevator system 102, the monitoring system 104, the controller tuner 310, and the like).

Still referring to FIG. 3, the example elevator system 102 also includes an electrical machine 306, which along with an inverter 307, may be part of a drive assembly 309 that controls movement of an elevator car 308 in a shaft. The elevator system 102 is shown to be in communication with a controller tuner 310 and with the monitoring system 104.

The controller tuner 310 interacts with the drive assembly 309 by utilizing hardware, software, and/or firmware, according to embodiments shown and described herein. In addition, the controller tuner 310 may include a non-transitory, computer readable medium configured for displaying and/or transmitting a data that may or may not be initiated by the technician 106 embodied as hardware, software, and/or firmware, according to embodiments shown and described herein.

While, in some embodiments, the controller tuner 310 may be configured as a general purpose computer with the requisite hardware, software, and/or firmware, in other embodiments, the controller tuner 310 may be configured as a special purpose computer designed specifically for performing the functionality described herein. For example, the controller tuner 310 may be a specialized device that includes a data-driven retuning assessment algorithm to calculate and determine a new set of a plurality of parameters and send or transmit the new set of the plurality of parameters 322, to the controller 305, which in turn implements the new set of parameters and outputs as the control signal 314 to affect or change a movement of at least one movable component of the elevator system 102, as discussed in greater detail herein.

As such, the controller tuner 310 may include a processor, input/output hardware, network interface hardware, data storage component, and a memory component. The memory component may be non-transitory computer readable memory. The memory component may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component may be configured to store operating logic and parameter modification logic (each of which may be embodied as a computer program, firmware, or hardware, as an example).

The processor may include any processing component(s) configured to receive and execute instructions (such as from the data storage component and/or memory component). The input/output hardware may include a monitor, keyboard, mouse, printer, camera, microphone, speaker, and/or other device for receiving, sending, and/or presenting data. The network interface hardware may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component may reside local to and/or remote from the controller tuner 310 and may be configured to store one or more pieces of data for access by the controller tuner 310 and/or other components, store data that may be received from an external device (e.g., the elevator system 102, the monitoring system 104, the controller tuner 310, and the like).

In operation, the control panel 304 of the elevator system 102 may transmit the control signal 314 to the electrical machine 306, which in cooperation with the inverter 307 controls the position, acceleration, deceleration, and the like, of the elevator car 308. The control signal 314 may also be transmitted to the controller tuner 310. Based on the control signal 314 input and the drive assembly moving the elevator car 308, sensors of the elevator system 102 may report an output signal 316 regarding performance and/or efficiency to the controller tuner 310 and also back to the control panel 304 of the elevator system 102.

Still referring to FIG. 3, the monitoring system 104 interacts with the elevator system 102 by utilizing hardware, software, and/or firmware, according to embodiments shown and described herein. In addition, the monitoring system 104 may include a non-transitory, computer readable medium configured for displaying and/or transmitting a data that may or may not be initiated by the technician 106 embodied as hardware, software, and/or firmware, according to embodiments shown and described herein.

While, in some embodiments, the monitoring system 104 may be configured as a general purpose computer with the requisite hardware, software, and/or firmware, in other embodiments, the monitoring system 104 may be configured as a special purpose computer designed specifically for performing the functionality described herein. For example, the monitoring system 104 may be a specialized device that includes specific hardware, software and/or firmware for monitoring data, providing alerts to the technician 106 via the electronic mobile device 107 (FIG. 1) receiving commands and/or instructions and communicating those commands and/or instructions to various components of the elevator system 102 (e.g., the controller tuner 310), as discussed in greater detail herein.

As such, the monitoring system 104 may include a processor, input/output hardware, network interface hardware, data storage component, and a memory component. The memory component may be non-transitory computer readable memory. The memory component may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component may be configured to store operating logic and parameter modification logic (each of which may be embodied as a computer program, firmware, or hardware, as an example).

The processor may include any processing component(s) configured to receive and execute instructions (such as from the data storage component and/or memory component). The input/output hardware may include a monitor, keyboard, mouse, printer, camera, microphone, speaker, and/or other device for receiving, sending, and/or presenting data. The network interface hardware may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component may reside local to and/or remote from the monitoring system 104 and may be configured to store one or more pieces of data for access by the technician 106, the controller tuner 310 and/or other components, store data that may be received from an external device (e.g., the elevator system 102, the controller tuner 310, the technician 106, and the like).

Still referring to FIG. 3, in operation, the elevator system 102 may be exchanging elevator system data 318 with the monitoring system 104, which is in turn in communication with the technician 106. Some examples of the elevator system data 318 gathered by the monitoring system 104 may include lifecycle and physical state of components (e.g., cables/belts, gears), average elevator speed, time to achieve nominal speed, acceleration and deceleration, elevator jerk, floor alignment or leveling, power consumption changes, and the like. Further, elevator system data 318 gathered by the monitoring system 104 may include historical data for any of the above-mentioned examples that may be stored within a database of the monitoring system 104 and/or remote to the monitoring system 104 where the monitoring system 104 may retrieve the data using the techniques described herein with respect to FIG. 1 and/or may have the data transmitted to the monitoring system 104.

The elevator system data 318 serves as input for a data-driven retuning assessment algorithm that assesses the need for controller retuning. Examples of algorithmic or analytic tools that may be employed by the monitoring system 104 include the Weibull distribution, the Rayleigh distribution, and/or logistic or generalized logistic distributions. In this example, the monitoring system 104 makes the initial determination as to whether the controller 305 of the elevator system 102 needs to be retuned.

Once the determination to retune is made and approved by the technician, for instance, the controller tuner 310 may generate new controller operating parameters 322 to improve the performance and/or efficiency of the elevator system 102. More specifically, the controller tuner 310 may execute a data-driven algorithm based on the control signal 314 and the output signal 316. The controller tuner 310 may then provide the new controller operating parameters 322 to the control panel 304 of the elevator system 102. It should be understood that in some examples the controller tuner 310 may be integrated within the control panel 304 as a dedicated board or even run as a process/thread on an existing elevator controller board (e.g., MHC2 or CGA). In still other examples, the controller tuner 310 may even be part of the monitoring system 104.

One example condition the elevator system 102 may experience is where the elevator car 308 accelerates poorly above or under a certain predefined value (i.e., underperforming), but there is no evidence of a bad component. Experiencing this condition may indicate that the elevator system's mechanical and/or electrical models have changed over time, which in turn means that the current controller tune will no longer provide the optimal results it once did. In this scenario, controller retuning can significantly improve the elevator system's performance and/or efficiency. By contrast, if in another example condition the monitoring system 104 detects a component in a critical state, the monitoring system 104 will recommend immediate replacement of that component rather than retuning.

Still referring to FIG. 3, the controller operating parameters 322 coming from the controller tuner 310 specify the new set of operating parameters that the controller 305 of the elevator system 102 should implement, as determined by the data-driven algorithm of the controller tuner 310. Furthermore, in some embodiments, the controller 305 of the example elevator system 102 may be a proportional-integral (PI) controller. In this embodiment, the controller operating parameters would be composed by the proportional gain, which is usually referred as Kₚ, and integrative time, which is usually referred as Tᵢ. Those having ordinary skill in the art will appreciate that a wide variety of data-driven methods can be used to calculate the operating parameters of many different controller implementations, and thus the controllers of the drive assemblies of the present disclosure are not at all limited to PI controllers.

For example, in other embodiments, the controller 305 of the example elevator system 102 maybe a proportional-integral-derivative controller. In this embodiment, the controller operating parameters would be composed by the proportional gain, which is usually referred as Kₚ, the integrative time, which is usually referred as Tᵢ, and the derivative time, which is usually referred to as T_{d}. Those having ordinary skill in the art will appreciate that a wide variety of data-driven methods can be used to calculate the operating parameters of many different controller implementations, and thus the controllers of the drive assemblies of the present disclosure are not at all limited to PI, PID, and the like controllers.

The systems and methods of the present disclosure provide an abundance of advantages, including reducing maintenance labor cost; improving elevator performance, travel comfort, efficiency, and customer satisfaction without replacing parts prematurely—all of which can be authorized and initiated from remote locations, reducing part replacement cost by prolonging the lifespan of components that are performing sub-optimally, improving ride quality, enabling new service models concerning retuning to generate new revenue streams, reducing elevator downtime, reducing the amount of time that technicians spend adjusting the elevator controller with respect to both maintenance-related operations and new installations, and reducing maintenance costs by using degraded, but healthy replacement components in limited circumstances.

The present disclosure contemplates a multitude of alternative configurations. For example, the monitoring system 104 and the controller tuner 310 may use an assortment of different analytic tools. As another example, the present disclosure contemplates utilizing a host of operating parameters associated with elevator systems. As yet another example, the present disclosure contemplates that either a subset, or all, of the components of the monitoring system 104 and/or the controller tuner 310 may be located at the elevator system 102, as opposed to remote from the elevator system 102. Likewise, the present disclosure contemplates using wide varieties of controller types and control methods.

### Example

One example application of the systems and methods of the present disclosure may provide for real-time monitoring and adjusting of an elevator car's speed and acceleration. When average values for speed and/or acceleration of the elevator car diverge from predefined acceptable ranges, retuning the host elevator system may be proposed. The data-driven retuning algorithm employed by a controller tuner 310 in this example may be based on a data-driven controller method known as virtual reference feedback tuning (VRFT). VRFT relies on a compilation of data to identify the operating parameters of a controller of a drive assembly of the elevator system that will make the closed-loop system perform optimally. The basic premise and advantage of VRFT is that it does not require a model to describe the process for designing a control system. VRFT is well suited to be applied to problems where a reliable process model is unknown, too difficult, or even seemingly impossible to obtain. Those having ordinary skill in the art will recognize that elevator systems are complicated and involve many variables to model. Some even have impossible-to-predict time-stress dependencies.

For reference, in conventional control design, a designer first selects a controller class. In this example, a PI controller C_{PI} (s) is utilized. Next, the designer needs to define a desired transfer function T_{d} (s) that describes desired closed-loop behavior of the position and/or acceleration of the elevator car 308. The desired transfer function T_{d} (s) can, in some cases, be difficult to define, though, depending on the method and the sophistication of the transfer function (e.g., defining a higher-order transfer function T_{d} (s) that describes a closed-loop system will naturally be more difficult to define). Yet, according to the present disclosure, VRFT methods may use available system input values and output values to directly identify the controller operating parameters. Continuing with the example PI controller, VRFT can be leveraged to output values for proportional gain K_{P} and integrative time Tᵢ to make the closed-loop system behave like the desired transfer function T_{d} (s) without defining a transfer function for the current elevator system (target plant).

Acceleration is directly related to poles of the desired transfer function T_{d} (s) because those are related to settling time, namely, how fast the closed-loop system reaches the set point. The data-driven algorithm of the controller tuner 310 may request an experiment, which can be performed either on an “open-loop” system (i.e., in this scenario, the current controller 305 and plant may be considered as a single system and another controller to be designed will work as a reference generator for the current controller, which may be a more complex approach) or on the current “closed-loop” system (i.e., in this scenario, the idea is to simply retune the existing controller 305 of the drive assembly 309 by calculating a new set operating parameters). The elevator car 308 may then move through the shaft as requested. The system may store data regarding the inputs, which will depend on how the retuning method is implemented, and regarding outputs, which in this example correspond to the electrical machine and speed and/or acceleration of the elevator car. The data may be sent to the algorithm, which will return the operating parameters for the retuned controller. The retuned controller 305 may then apply and test these operating parameters and, if they comply with the predefined acceptable ranges, they may be permanently applied. Otherwise, another retuning process will be requested. Further, in some cases if the retuning process fails an arbitrary number of times, retuning will be canceled, and a technician will be notified that automatic and/or autonomous retuning is not possible.

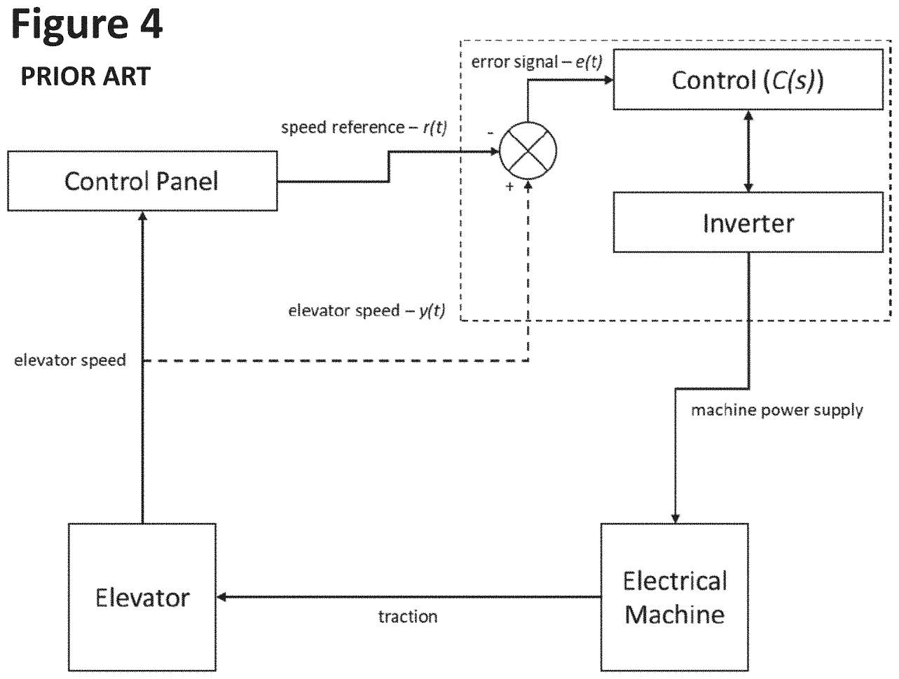

A conventional elevator system implementation is shown in FIG. 4.

An elevator system plant of the present disclosure can be described by a transfer function GE(s) that represents the behavior of the inverter 307, the electrical machine 306, and the elevator car 308. The input of the system may be the inverter's control input, while the output of the system may be the elevator car/electrical machine speed. An elevator closed-loop system T(s) may be defined as:

$$T ( s ) = \frac{{G}_{E} ( s ) C ( s )}{1 + {G}_{E} ( s ) C ( s )}$$

where, for a PI controller, C(s) is defined as

$$C ( s ) = {K}_{P} ( 1 + \frac{1}{{T}_{{i}^{S}}} ) .$$

With respect to a closed-loop experiment, the VRFT looks for K_{P} and Tᵢ that make T(s)=T_{d}(s). For a PID controller, C(s) is defined as

$$C ( s ) = {K}_{p} ( 1 + \frac{1}{{T}_{{i}^{S}}} + {T}_{d} s )$$

Kₚ is the proportional gain, Tᵢ is the integration time and T_{d} is the derivative time. It can also be expressed as:

$$C ( s ) = {K}_{p} + \frac{{K}_{i}}{s} + {K}_{d} s$$

where Kᵢ=Kₚ/Tᵢ and K_{d}=KₚT_{d}.

On the other hand, in other embodiments with adding a second controller, the elevator closed-loop system would depend on a cascade implementation of a C_{V}(s) with the current C(s). Where C_{V}(s) is the controller that will be calculated by the method, following the same principle, a C_{V}(s) will be identified that makes T(s)=T_{d}(s). C(s) remains untouched.

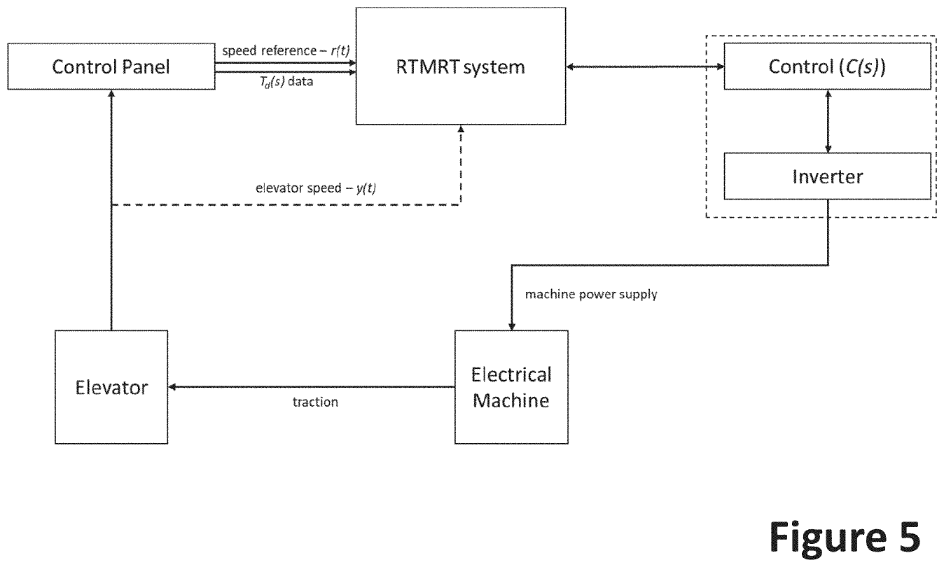

Now referring to FIG. 5, where the implementations for both the open and closed-loop scenarios are schematically depicted. In the closed-loop implementation scenario, the real-time monitoring and retuning system (RTMRTS) may forward an error signal (e(t)=y(t)−r(t)) to the controller C(s) while it will also be responsible for monitoring the speed and acceleration of the system where y(t) is the output signal 316 such as a speed of the elevator car and r(t)) is a reference or target value generated by a component of the elevator system 102, such as by the control panel 304, the controller 305, the inverter 307, and the like.

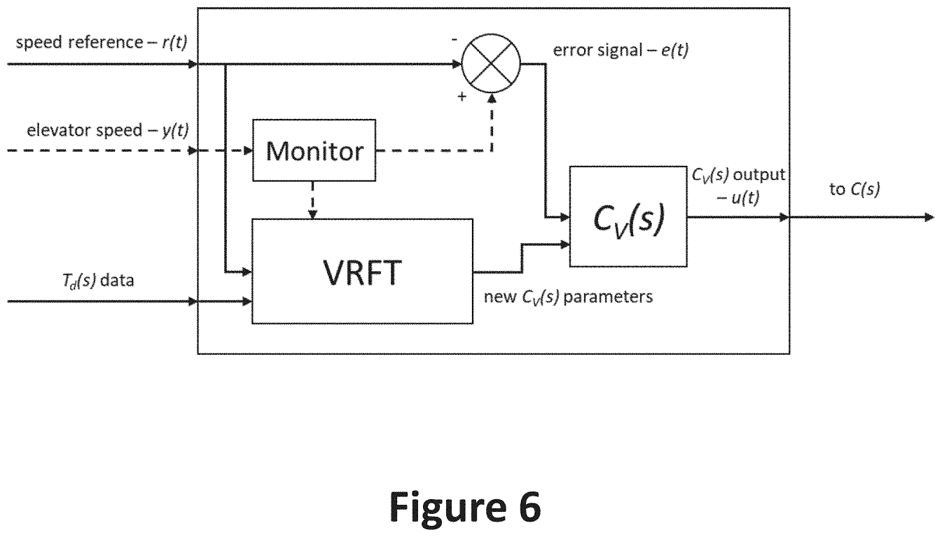

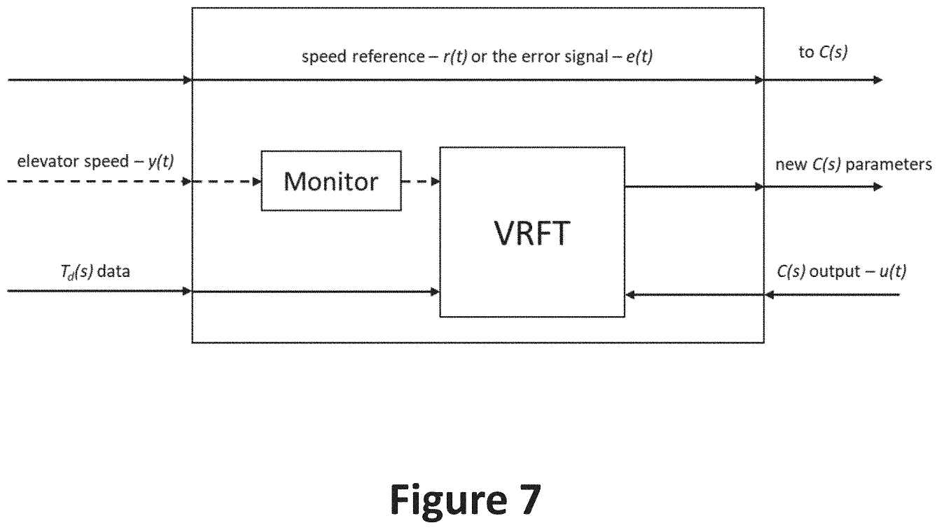

When elevator performance departs from the predefined acceptable performance ranges (e.g., the performance of the elevator system 102, and components thereof, do not meet or exceed the predetermined performance threshold), the RTMRTS uses a VRFT algorithm to compute a new set of operating parameters for the controller C(s), which will be passed and stored temporarily on C(s). The whole closed-loop system may be tested, and if it passes, the retuned controller will be permanently saved on C(s). In the open-loop scenario, the RTMRTS becomes the controller C_{V}(s) and is responsible for passing the output of C_{V}(s). That is, in some embodiments, in the open loop system, the components of the elevator system 102 may not be figured with a monitoring system 104 or a controller tuner 310 in the same manner with the same communications as described with respect to FIGS. 1 and 3. As such, in these embodiments, the RTMRTS may perform the functionality of the controller C_{V}(s) and is responsible for passing the output of C_{V}(s). FIG. 6 shows a block diagram of the open-loop implementation scenario, whereas FIG. 7 shows a block diagram of the closed-loop implementation scenario.

In some instances of the present disclosure, controller class is fixed and is based on the current controller class (alternatively, a couple of different controller classes such as PI and proportional-integral-derivative (PID) controllers may be tested by an algorithm on the open-loop scenario such that the best controller can be defined by an arbitrary cost-function comparison), and the desired transfer function will be automatically defined by the elevator operating parameters (i.e., more specifically, nominal acceleration), that is, T_{d}(s) will be defined by information stored in the elevator's control panel.

The approach of the present disclosure provides better control over an elevator car's acceleration. In particular, a fully automated method will use a nominal acceleration value to define the closed-loop behavior of the system, resulting in better acceleration performance. Consequently, the present disclosure provides for faster elevators overall, as elevator cars will reach nominal speed faster. Consequently, the present disclosure provides for more comfortable elevators, as better control over acceleration directly impacts the ride's comfort because acceleration is one of the most-noticeable ride characteristics that passengers experience. Consequently, the present disclosure provides for energy savings, as a refined controller tune can greatly improve the elevator's power consumption, especially by avoiding abrupt accelerations.

The present disclosure consistently refers to continuous-time implementations, which is an ideal condition. In reality, however, conditions more closely align with discrete-time implementations. Yet this disparity does not present a problem, as VRFT and other data-driven methods can also be used for discrete-time design. Those having ordinary skill in the art will understand this distinction and the benefit of VRFT, which is why the present disclosure does not design a continuous-time solution and then discretize it. The present disclosure is continuous-time domain based only because continuous-time based implementations are easier to understand.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An elevator system having at least one movable component and at least one component generating a reference signal, the elevator system comprising:
a controller that generates a control signal;
an output signal indicative of a movement of the at least one movable component of the elevator system based on the control signal; and
a controller tuner communicatively coupled to the controller, the controller tuner receives the output signal and the reference signal to calculate an error signal, the controller tuner uses the error signal to calculate a corrected control signal and transmits the corrected control signal to the controller,
wherein the corrected control signal manipulates the control signal generated by the controller to change the movement of the at least one movable component.

2. The system of claim 1, wherein the controller generates the control signal based on a plurality of preset parameters stored within the controller.

3. The system of claim 2, wherein the corrected control signal is determined using an algorithm to compute a new set of the plurality of preset parameters, the algorithm is data driven.

4. The system of claim 3, wherein the corrected control signal includes a manipulation of at least one of the plurality of preset parameters of the controller.

5. The system of claim 4, wherein the reference signal is a target speed of the at least one movable component and the output signal is indicative of a current speed of the movement of the at least one movable component.

6. The system of claim 4, wherein the reference signal is a target acceleration rate of the at least one movable component and the output signal is indicative of a current acceleration rate of the movement of the at least one movable component.

7. The system of claim 4, wherein the elevator system further comprises:
a drive assembly having:
an electrical machine; and
an inverter,
wherein the electrical machine and the inverter cooperate to generate the output signal to control the movement of the at least one movable component based on the control signal.

8. The system of claim 7, wherein the elevator system further comprises:
a monitoring system that remotely monitors the output signal of the elevator system; and
a mobile device communicatively coupled to the monitoring system,
wherein when the error signal of the elevator system fails to meet a predetermined performance threshold, the monitoring system alerts the mobile device.

9. The system of claim 8, wherein a user of the mobile device remotely approves transmitting the corrected control signal from the controller tuner to the controller.

10. A method for autonomously retuning an elevator system, the elevator system having at least one movable component, the method comprising:
analyzing, by a monitoring system, an output signal of the elevator system, the output signal is indicative of a movement of the at least one movable component;
determining, by the monitoring system, when a retune of a controller that generates a control signal is required, the controller having a plurality of preset parameters that influence the control signal which controls the movement of the at least one movable component;
gathering, by the monitoring system, a plurality of data related to operations of the at least one movable component associated with the output signal based on the control signal;
computing via an algorithm, by a controller tuner, a new set of the plurality of preset parameters, the new set of the plurality of preset parameters having at least one parameter different from the plurality of preset parameters;
transmitting, by the controller tuner, a corrected control signal to the controller; and
applying, by the controller, the corrected control signal to the at least one movable component to change the movement of the at least one movable component.

11. The method of claim 10, further comprising after the step of determining, by the monitoring system, whether the retune of the controller that generates the control signal is required, the controller having the plurality of preset parameters that influence the control signal:
alerting, by the monitoring system, a mobile device communicatively coupled to the monitoring system that the retune of the controller that generates the control signal is required; and
receiving, by the monitoring system, an approval from the mobile device to transmit the corrected control signal to the controller.

12. The method of claim 10, further comprising:
gathering, by the monitoring system, a second plurality of data related to operations of the at least one movable component of the elevator system associated with the output signal based on the corrected control signal.

13. The method of claim 12, further comprising:
determining, by the monitoring system, whether the second plurality of data related to operations of the at least one movable component of the elevator system associated with the output signal based on the corrected control signal meets a predetermined performance threshold.

14. The method of claim 13, further comprising:
storing, by the controller, the new set of the plurality of preset parameters for the corrected control signal as the control signal when the second plurality of data meets the predetermined performance threshold.

15. The method of claim 13, further comprising:
computing via the algorithm, by the controller tuner, a second new set of the plurality of preset parameters when the second plurality of data fails to meet the predetermined performance threshold, the second new set of the plurality of preset parameters having at least one parameter different from the new set of the plurality of preset parameters;
providing, by the controller tuner, a second corrected control signal to the controller, and
applying, by the controller, the second corrected control signal to change the movement of the at least one movable component.

16. The method of claim 10, wherein the algorithm is a data driven algorithm.

17. An elevator system having an elevator car, a shaft and a drive assembly, the drive assembly having an electrical machine and an inverter that cooperate to generate an output signal to cause a movement of the elevator car through the shaft, the elevator system comprising:
a controller having a plurality of preset parameters stored within the controller that generates a control signal;
a monitoring system that remotely monitors the output signal of the elevator system; and
a controller tuner communicatively coupled to the controller and to the monitoring system, the controller tuner includes a data driven algorithm that autonomously calculates a corrected control signal, the corrected control signal having a new set of the plurality of preset parameters, the controller tuner transmits the corrected control signal to the controller,
wherein the transmitting of the corrected control signal to the controller manipulates at least one of the plurality of preset parameters based on the new set of the plurality of preset parameters to change the control signal of the controller to change the movement of the elevator car through the shaft.

18. The elevator system of claim 17, wherein the monitoring system determines that a manipulation of at least one of the plurality of preset parameters of the controller is required by calculating an error signal, the error signal is calculated by subtracting the output signal from a reference signal generated from the drive assembly.

19. The elevator system of claim 17, wherein when the monitoring system determines that manipulation of the least one of the plurality of preset parameters of the controller is required, the monitoring system instructs the controller tuner to execute the data driven algorithm.

20. The elevator system of claim 18, further comprising:
a mobile device communicatively coupled to the monitoring system,
wherein when the monitoring system determines that the manipulation of the least one of the plurality of preset parameters of the controller is required, the monitoring system alerts the mobile device.
